(19) United States
(12) Patent Application Publication
(10) Pub. No.: US 2018/0137225 A1
(43) Pub. Date: May 17, 2018

(54) METHOD AND SYSTEM FOR BUILDING A CELL LIBRARY WITH SEGMENTED TIMING ARC DELAY MODEL

(71) Applicant: Byungha Joo, San Jose, CA (US)

(72) Inventor: Byungha Joo, San Jose, CA (US)

(21) Appl. No.: 15/351,771

(22) Filed: Nov. 15, 2016

(51) Int. Cl. G06F 17/50

(52) U.S. Cl. CPC G06F 17/5031

(57) ABSTRACT

Multiple timing arc gate delay modelling method is described. Propagation delay can be divided into several timing arcs at circuit threshold voltage. Additionally, each timing arc can be modelled as a function of actual source of driving force. The logic threshold voltage of the functional gates is one single voltage level, which is usually half of the supplied voltage. Therefore, the RC tree model which is extracted from the wires is still valid. In this way, precise voltage based delay calculation is accomplished while maintaining the same interfacing method with passive RC elements from wirings.

### FIELD OF THE INVENTION

The invention is in the field of electronic design automation (EDA), and more particularly, is related to system and method to enable accurate timing analysis of logical gates in a VLSI chip design.

### BACKGROUND OF THE INVENTION

Timing analysis is one of key verification steps in every design flow for VLSI chips. Accurate delay modeling is increasingly becoming an important aspect of a VLSI chip design as the complexity of chips increases. In the past, higher throughput was the priority in designing VLSI chips. The art of VLSI chip design has evolved, and now, the power efficiency of the VLSI chip has become the one of the most important design goals, especially for mobile applications. This power and performance co-optimization can be achieved by maximizing utility of a clock period with useful data transactions. In other words, minimizing redundant timing margins in a clock period can eliminate waste of resource in designing of a VLSI chip. The precise gate delay model is a must-have to achieve this goal.

Gate delay model has been studied for quite a long time in the field of VLSI chip design. CMOS switching behavior was described in the linear circuit model, and its propagation delay from input to output was modeled in a function of resistor and capacitor product. In conventional gate delay models, propagation delay is viewed as a single piece of timing arc measured from a reference voltage point of an input to a reference voltage point of an output. In most conventional delay models, half of the supply voltage is used as the logical reference voltage when measuring the propagation delay of a logic gate in cell library.

FIG. 1A is a timing diagram illustrating propagation delay from input to output of a logic gate using a conventional gate delay modeling scheme. As shown in FIG. 1A, the conventional delay modeling scheme generally assumes that a logic gate is operative to change its output to the opposite logic level when the input provided to the gate crosses the logical threshold voltage (V_{REF}), for example 50% of supply voltage (½VDD) for simplicity. In such a conventional delay modeling scheme, the propagation delay is defined with a timing arc between two end points A and B; the point A being the point in time when the voltage of the input (i.e., the output of the previous logic gate) rises or falls across the logical threshold voltage V_{REF}_{_}A; and the point B being the point in time when the voltage of the output of the present gate rises/falls across the logical threshold voltage V_{REF}_{_}B. However, the logic gate has a circuit threshold voltage V_{THC}, which is the actual input voltage level (as opposed to logical reference threshold voltage) that makes the output logic level transit to the opposite logic level. In the present disclosure, such actual threshold voltage of the logic gate is referred to as the circuit threshold voltage V_{THC}. The circuit threshold voltage level may be different from the logical reference threshold voltage V_{REF} used in the propagation delay definition. The actual gate threshold voltage V_{THC} of a given logic gate may be higher or lower than the reference voltage V_{REF}. Such gap between the logic threshold voltage V_{REF} and circuit threshold voltage (e.g., |½VDD−V_{THC}|) can result in a negative value in propagation delay, which cannot be accommodated in CHARMS delay modeling scheme.

Depending on direction (e.g., rise or fall) of the input and output signals, the propagation delay (T_{PHL}, T_{PLH}) may come out to be a negative value, that is, the logic gate generates the output even before the input is provided. By way of an example, when a logic gate with the circuit threshold voltage V_{THC} far from the logical threshold voltage V_{REF} has a very slow changing input signal and small output loading, the output of such logic gate can be determined before the voltage of the input reaches the logical threshold voltage V_{REF}. This is how the negative gate delay occurs. The transistor level circuit of the logic gate may have been designed correctly, but it may not be comprehensible by a gate level simulator because the gate level simulator may not be configured to acknowledge the occurrences of output transition before input transition arrives.

FIG. 1B illustrates consequences of assuming a single reference threshold voltage for multiple logic gates in a circuitry. Referring to FIG. 1B, each logic gate has its own circuit threshold voltage (V_{THC1}, V_{THC2}, V_{THC3}, V_{THC4}). The first logic gate and the fourth logic gate have the circuit threshold voltage, which are same as the logical threshold voltage (e.g., ½V_{DD}). However, the circuit threshold voltage V_{THC2} of the second logic gate is lower than its logical threshold voltage. Also, the circuit threshold voltage V_{THC3} of the third logic gate is higher than its logical threshold voltage. In this situation, the second logic gate will be operative to change its output to an opposite logic level at point A of N2, even before the input reaches the logical threshold voltage V_{REF}, thereby creating the time segment Delay 1 unaccounted in the conventional propagation delay model. Further, the third logic gate will be operative to change its output to an opposite logic level at point A of N3, which will not occur even when the input reaches the logical threshold voltage V_{REF}, thereby creating the time segment Delay 2 unaccounted in the conventional propagation delay model. As a result, gate delay based on the specific reference voltage V_{REF} is overlapped by two different driving logic gates depending on part of timing—before crossing the circuit threshold voltage V_{THC} or after crossing the threshold voltage V_{THC}. This difference between logical threshold voltage V_{REF} to circuit threshold voltage V_{THC} is the fundamental source of inaccuracy in gate delay calculation. For a logic gate which has circuit threshold voltage V_{THC} near the logical threshold voltage V_{REF}, such as the first logic gate and the fourth logic gate, delay of the logic gate can be measured and estimated within tolerable margin of error. However, other logic gates with the circuit threshold voltage V_{THC} far from the logical threshold voltage V_{REF}, it is extremely difficult to estimate the propagation delay with simple linear calculation.

Above described propagation delay errors, especially the occurrences of negative delay can be of a major problem when the VLSI chip design is to be validated under other process, voltage and temperature (PVT) corners. For instance, a system-on-Chip (SoC) includes a number of gate blocks, which used to be provided on discrete chips with their own process, voltage and temperature (PVT) corner validations. To integrate such gate blocks on a single die as a SoC, multiple cell architectures and their front-end and back-end views from those blocks must be ready early in the SoC design schedule with a super set of PVT corners of characterization. Industry uses a “derating factor” for PVT corner migration with the assumption that gate delay can be linearly interpolated. However, linear interpolation with a derating factor cannot be applied to a negative delay value because applying the derating factor (e.g., product of derating factor and the the negative delay value) will make the negative delay value go further in the opposite direction of other timing values in the cell.

It should be noted that positive delay values from slow input are not error proof in the application of derating factors. A gate delay with slow input transition and large output loading has a positive value, but large amount of slow input transition effect is hidden in the positive value. Thus, simple linear interpolation using a derating factor can also require a large margin of errors. Due to such inaccuracies in the conventional delay model scheme, high-end design validation necessitates fully characterized cell libraries at increased number of PVT corners. Each set of new cell library characterization process can be a very time consuming and computing-power intensive task in a cell library development, which in turn, increases the entire VLSI chip design schedule.

Accordingly, it is desirable to provide an improved system and method for creating a cell library of logic gates with accurate representation of delays in the logic gate. This accurate gate delay model can contribute toward maximizing utility of a clock period with useful data transactions, thereby achieving power and performance co-optimization of a VLSI chip design.

### SUMMARY OF THE INVENTION

To improve gate delay accuracy without unduly increasing cell library size and analytical complexity, the definition of propagation delay is not modified. In the present disclosure, propagation delay of a given logic gate is referenced from a logical threshold voltage level ½V_{DD} while parasitic wire RC models are calculated in the conventional passive element timing model. However, the logic gate is no longer a black boxed. In the present invention, propagation delay from input to output is divided into multiple timing arcs (timing segments) and the anchor point of the timing arcs is the circuit threshold voltage V_{THC}. Each arc represents a distinctive characteristic with respect to the power source element of that specific timing arc. Function of the anchor determines how the timing arcs are combined to calculate appropriate propagation delay. The circuit threshold voltage V_{THC} remains within an acceptable error range in PVT variation. As a result, each timing arc can be converted to other PVT corners individually within an acceptable error range.

In one aspect, the present disclosure is related to a segmented delay modeling computer system. In one embodiment, the computer system includes at least one processing unit and memory operably associated with the at least one processing unit. A cell library building tool storable in memory and executable by the at least one processing unit performs a propagation delay analysis of a cell having at least one logic gate. The cell library building tool comprises a gate level simulator, which is configured to generate an input signal for the at least one logic gate as a function of slew of an input voltage ramp signal and load capacitance. The cell library building tool further comprises a timing calculator and a logic gate characteristic database. The logic gate characteristic database stores various characterization data that describe driving behavior of the logic gate, and the timing calculator is configured to obtain a plurality of characteristic of the logic gate to calculate a propagation delay between an input signal and an output signal provided at an input node and an output node of the logic gate, respectively. Propagation delay is represented with two timing arcs that are connected at circuit threshold voltage V_{THC}, the first timing arc being the receiver arc and the second timing arc being the driver arc. More specifically, the receiver arc represents a timing segment in which the voltage of the input signal reaches from a logical threshold voltage V_{REF} to a circuit threshold voltage V_{THC}, at the input node of the logic gate. The driver arc represents a timing segment from a point in time when the input signal is at the circuit threshold voltage V_{THC} until the point in time when the output signal of the logic gate reaches a logical threshold voltage V_{REF} at the output node of the logic gate. The receiver arc and the driver arc, which collectively represents the propagation delay between the input and the output of the gate, are linked at the anchor point where the voltage of the input is at the circuit threshold voltage V_{THC}.

In another aspect, the present disclosure is related to a method of creating a cell library with a segmented propagation delay model. The method includes a step for identifying a circuit threshold voltage of a logic gate. Circuit threshold voltage V_{THC} means the input voltage level which makes output logic level transit to opposite logic level. Once the circuit threshold voltage is determined, a plurality of logic gate characteristics is obtained from the logic gate characteristic database. The plurality of logic gate characteristics includes a driver arc and a transition time. The driver arc is a length in time measured from when an input signal at the input node of the logic gate reaches the circuit threshold voltage V_{THC} and until when an output signal at the output node of the logic gate reaches a logical threshold voltage V_{REF} of the logic gate. The transition time is a length in time for the signal to reach from its predetermined high voltage level V_{GH} to the predetermined low voltage level V_{GL} or to reach from its predetermined low voltage level V_{GL} to the predetermined high voltage level V_{GH}. The method further includes a step for identifying a receiver arc, which is a length in time for the input signal at the input node of the logic gate transits between a logical threshold voltage of the logic gate to the circuit threshold voltage of the logic gate. After the receiver arc is obtained, the propagation delay is calculated by adding the receiver arc and the driver arc.

Additional aspects related to these embodiments will be set forth in part in the description which follows, and in part will be apparent from the description or may be learned by practice of the invention. Aspects of the invention may be realized and attained by means of the elements and combinations of various elements and aspects particularly pointed out in the following detailed description and the appended claims.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention.

FIG. 1A is a timing diagram illustrating propagation delay of a logic gate defined in a conventional propagation delay model.

FIG. 1B is a timing diagram illustrating unaccounted delay in a logic gate in a conventional propagation delay model scheme, which is caused by the difference between the circuit threshold voltage and the logic threshold voltage.

FIG. 2 is a block diagram illustrating an exemplary segmented propagation delay modeling computer system.

FIG. 3 is a diagram illustrating proportion for a Receiver Arc of propagation delay in relation to the transition time of an input for a given logic gate.

FIGS. 4A-4D are timing diagrams, each illustrating how propagation delay of a logic gate is constructed by using a Receiver Arc and a Driver Arc.

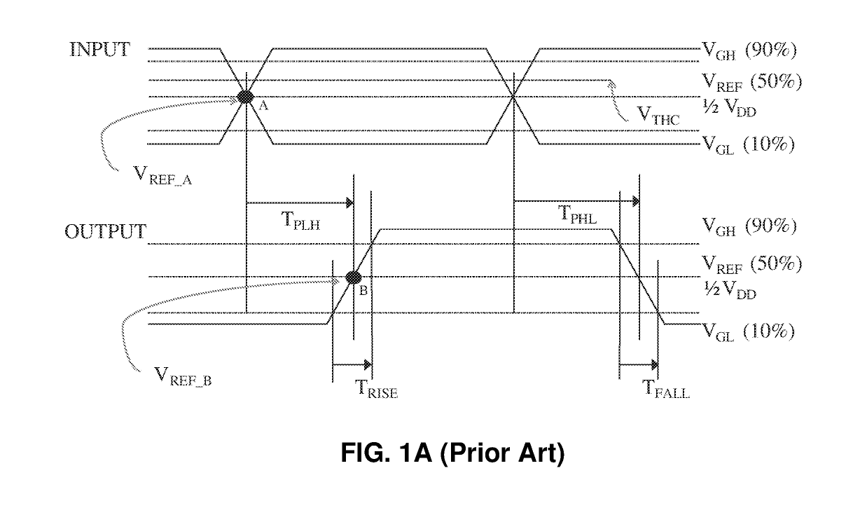

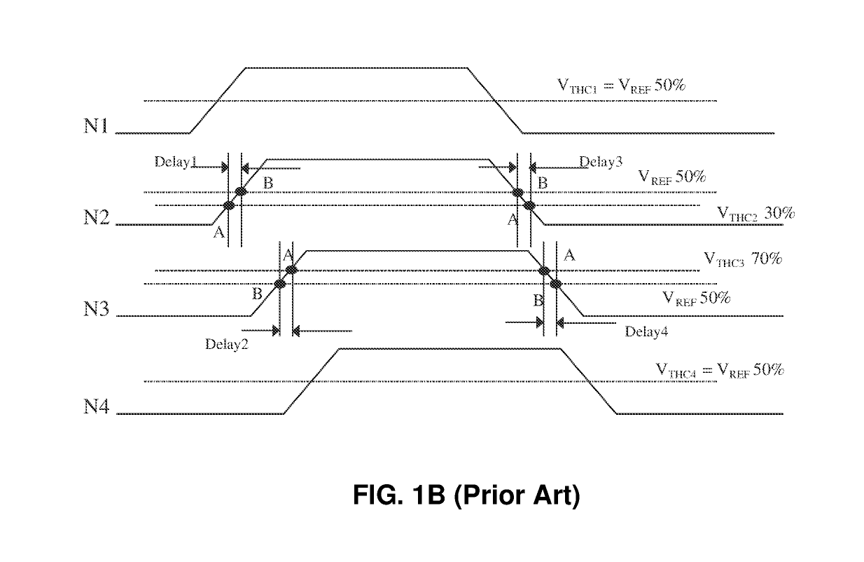

### DETAILED DESCRIPTION OF THE INVENTION

In the following detailed description, reference will be made to the accompanying drawings. The aforementioned accompanying drawings show by way of illustration, and not by way of limitation, specific embodiments and implementations consistent with the principles of the present invention. These implementations are described in sufficient detail to enable those skilled in the art to practice the invention, and it is to be understood that other implementations may be utilized and that structural changes and/or substitutions of various elements may be made without departing from the scope and spirit of the invention.

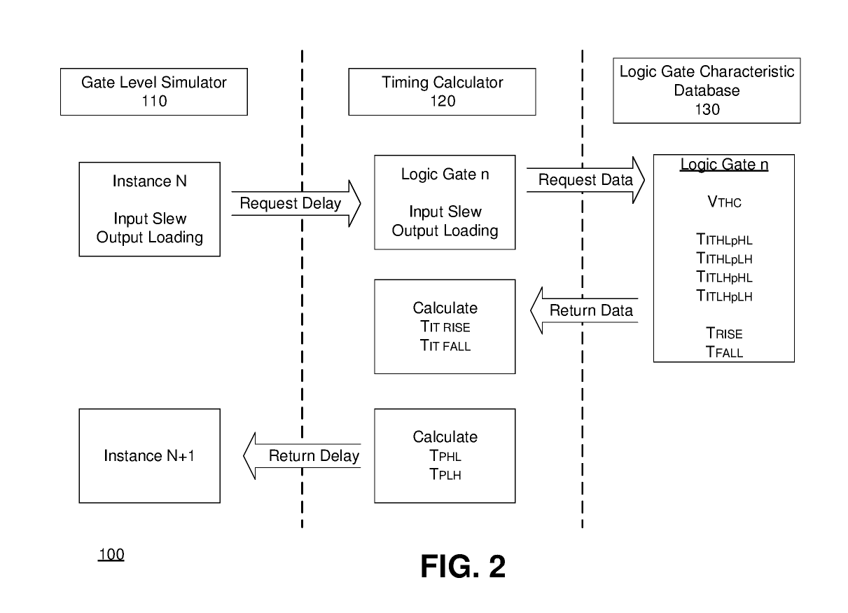

FIG. 2 is a schematic block diagram of a computer system adapted to use the segmented propagation delay model, according to an embodiment of the present disclosure. Referring to FIG. 2, gate level simulator 110 has a list of instances in a given design netlist. For each instance in the netlist, the gate level simulator 110 requests the timing calculator 120 for a delay value. When the gate level simulator 110 makes this request, it provides information regarding the instance such as an instance name, output slew rate from preceding gate as input slew rate and capacitive loading at the output node of the instance. Upon receiving the request from the gate level simulator 110, the timing calculator 120 sends one or more queries to the logic gate characteristic database 130 for various parameters for use in calculation of propagation delay of the instance.

In the system and method for creating the cell library of the present disclosure, the propagation delay from input to output is defined by using two timing arcs: the receiver arc and the driver arc. As mentioned above, the input signal and the output signal each swings between its high level voltage V_{GH} and the low level voltage V_{GL}. The time interval for the given signal to change between its high level voltage V_{GH} and the low level voltage V_{GL} is referred to as the transition time (T_{RISE}, T_{FALL}) of the signal. In particular, the time interval of the signal changing from the defined high level V_{GH} to the defined low level V_{GL} is referred to as Transition time, high-to-low-level T_{FALL}. Also, the time interval of the signal changing from the defined low level V_{GL} to the defined high level V_{GH} is referred to as Transition time, low-to-high-level T_{RISE}. The transition time (i.e., T_{RISE} and T_{FALL}) of the logic gate may be stored in the logic gate characterization database 130.

In a conventional cell library building system and/or in the conventional method, a logic state of the logic gate is generally assumed to change at the midway between the defined high level voltage V_{GH} and the defined low level voltage V_{GL} of the input signal. Therefore, such midway between the defined high level voltage V_{GH} and the defined low level voltage V_{GL} of the input signal is generally defined as the logic threshold voltage V_{REF} of the logic gate, and all timing calculation have been measured from and until the given signal crosses its logic threshold voltage V_{REF} in the conventional delay model scheme.

Such logic threshold voltage V_{REF}, however, is rarely the same as the actual circuit threshold voltage V_{THC} where the transition of the output signal occurs in the logic gate. Instead, the logic gate usually has its unique circuit threshold voltage V_{THC} for enabling the output to change its logic state. Unlike the conventional delay model, which uses the logic threshold voltage V_{REF} of the input signal as the transition triggering point of the output signal, the present disclosure uses the circuit threshold voltage V_{THC} of the input signal as the transition triggering point of the output signal of the logic gate. As such, the circuit threshold voltage V_{THC} of the logic gate may also be provided from the logic gate characteristic database 130. In this regard, the circuit threshold voltage V_{THC} for each input pin of the logic gate may be measured using DC analysis during logic gate characterization process and may be stored in the logic gate characterization database 130. In all of the examples in the present disclosure, 50% of the supply voltage is described as the logical threshold voltage V_{REF} for convenience. However, it should be appreciated that logical threshold voltage can be set to be above or below 50% of the supply voltage. For example, in some embodiments, the logical threshold voltage may be set to be any one of 30%, 40%, 60% and 70% of the supply voltage, depending on the type (e.g., a-Si, Oxide, Poly-Si) of the transistors used in building the logic gate.

Other parameters provided from the logic gate characteristic database 130 includes at least one of the driver arc values from circuit threshold voltage point of the input signal at the input node of the logic gate until the logical threshold voltage point of the output signal at the output node of the logic gate. In the conventional timing model, the direction of transition for the input signal and the output signal was ignored in defining the propagation delay. In other words, the propagation delay was simply measured from when the input signal crossed the logical threshold voltage V_{REF} until the output signal crossed the logical threshold voltage V_{REF}, irrespective of their transition directions (i.e., rise or fall). In order to define the propagation delay by using the circuit threshold voltage V_{THC} of the logic gate, the transition direction of the input signal and the output signal for the given gate switching transaction must be considered. In this regard, the combination of two transition directions (i.e., rise and fall) of the input signal and the two transition directions (i.e., rise and fall) of the output signal provide four distinct types of driver arcs.

More specifically, high-to-low-level input to high-to-low-level output driver arc (T_{ITHLpHL}) refers the time interval from the circuit threshold voltage V_{THC} point of the input signal at the input node of the logic gate to the logical threshold voltage point of output signal at the output node of the logic gate, in which the input signal transitioning from the defined high level V_{GH} to the defined low level V_{GL} and the output signal transitioning from the defined high level V_{GH} to the defined low level V_{GL}. The low-to-high-level input to high-to-low-level output driver arc (T_{ITLHpHL}) refers the time interval between the circuit threshold voltage point on the input signal at the input node of the logic gate and logical threshold voltage point on the output signal at the output node of the logic gate, in which the input signal transitioning from the defined low level V_{GL} to the defined high level V_{GH} and the output signal transitioning from the defined high level V_{GH} to the defined low level V_{GL}. The high-to-low-level input to low-to-high-level output driver arc (T_{ITHLpLH}) refers the time interval between the circuit threshold voltage point on the input signal and logical threshold voltage point of the output signal, in which the input signal changing from the defined high level V_{GH} to the defined low level V_{GL} and the output signal changing from the defined low level V_{GL} to the defined high level V_{GH}. Lastly, the low-to-high-level input to low-to-high-level output driver arc (T_{ITLHpLH}) refers the time interval between the circuit threshold voltage point on the input signal and logical threshold voltage point on the output signal, in which the input signal changing from the defined low level V_{GL} to the defined high level V_{GH} and the output signal changing from the defined low level V_{GL} to the defined high level V_{GH}. The timing arc from circuit threshold voltage point of the input to the output crossing the logical threshold voltage of the logic gate is called the “driver arc”, since the output driver of this logic gate is the “driving source” to make a change in output node.

Once the driver arc is obtained from the logic gate characterization database 130, the timing calculator 120 will need to identify the remaining piece of the propagation delay, which is the receiver arc. Unlike the driver arc, which is stored in the logic gate characterization database 130, the receiver arc is dynamically calculated by the timing calculator 120 during the logic simulation by the system 100.

The timing arc from input transitioning between the logical threshold voltage V_{REF} to the circuit threshold voltage V_{THC} is called the “receiver arc” because the logic gate is observing the input signal level change until the voltage level reaches circuit threshold voltage V_{THC}. In this “receiver arc”, propagation delay is determined by the input driving force from the previous logic gate (N−1). That is, the driving source of a given logic gate during the receiver arc is the output of an instance which is connected to the input node of that given logic gate. Accordingly, part of the propagation delay for the present logic gate (N) is calculated from the previous gate (N−1) output slew timing. In this regards, the timing of the “receiver arc” is derived using the Triangle Proportionality Theorem in conjunction with the appropriate transition time (i.e., T_{RISE} or T_{FALL}) of the previous instance (N−1), which are available from the logic gate characterization database 130.

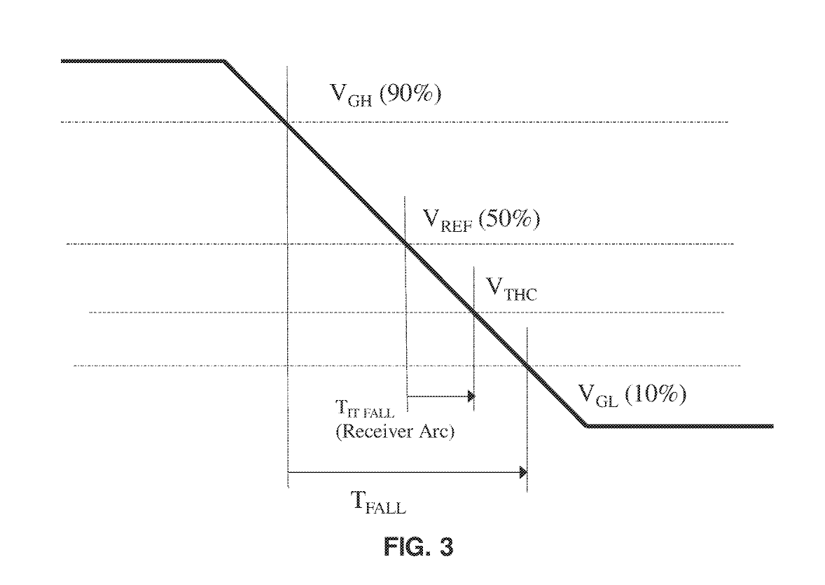

FIG. 3 illustrates how the receiver arc value is determined by the timing calculator. As shown, the time segment between when the input signal is at the logical threshold voltage V_{REF} (in this case, half of the supply voltage ½VDD) and when the input signal is at the circuit threshold voltage V_{THC} can be derived using the triangle proportionality theorem. This timing segment is referred to as the receiver arc in the present disclosure. In FIG. 3, the receiver arc in falling direction is illustrated. Depending on the transitioning direction of the input signal, however, the receiver arc can be described as falling receiver arc (T_{IT FALL}) or as rising receiver arc (T_{IT RISE}), which is calculated by one of the following equations EQ1 and EQ2:

T_{IT FALL (N)}=(V_{REF}−V_{THC})×T_{FALL (N-1)}÷(V_{GH}−V_{GL}) EQ1:

T_{IT RISE (N)}=(V_{THC}−V_{REF})×T_{RISE (N-1)}÷(V_{GH}−V_{GL}) EQ2:

Using the equations EQ1 and EQ2 above, relationship between V_{REF} and V_{THC} will determine the sign (i.e., positive or negative) of the receiver arc. As will be described in further detail below, this is an important feature as it allows for linear interpolation of the receiver arc for the purposes of PVT migration. The transition time T_{RISE} and T_{FALL} will always be a positive value, and, by definition, high level supply voltage V_{GH} is always higher than the low level supply voltage V_{GL}. However, the circuit threshold voltage V_{THC} may be higher or lower than the logical threshold voltage V_{REF} because V_{THC} is determined by transistor circuit topology of each logic gate. Accordingly, the value of the receiver arc T_{IT RISE} and T_{IT FALL} may be a negative value due to the relationship between the circuit threshold voltage V_{THC} and the logical threshold voltage V_{REF}.

As briefly mentioned above, the propagation delay from input to output of a logic gate is the sum of two timing arcs: receiver arc and the driver arc. Accordingly, the logic gate's propagation delay such as T_{PLH} or T_{PHL} can be determined once the receiver arc T_{IT FALL} or T_{IT RISE} is determined by the timing calculator 120. The propagation delay determined by the timing calculator 120 is returned to the gate level simulator 110, and the gate level simulator 110 continues on with the next instance until the last instance of the circuit.

TABLE 1
Propagation Delay Formula

| | input to | | |
|---|---|---|---|
| | output | | |
| Propagation | relationship | Direction | |
| Delay | (Anchor Function) | of Input | Equation |
| T_{PHL} | Non-Inverting | Falling | EQ3: T_{PHL} = T_{IT FALL} + |
| | | | T_{ITHLpHL} |
| | Inverting | Rising | EQ4: T_{PHL} = T_{IT RISE} + |
| | | | T_{ITLHpHL} |
| T_{PLH} | Non-Inverting | Rising | EQ5: T_{PLH} = T_{IT RISE} + |
| | | | T_{ITLHpLH} |
| | Inverting | Falling | EQ6: T_{PLH} = T_{IT FALL} + |
| | | | T_{ITHLpLH} |

As shown in Table 1 above, the input to output logical relationship determines the receiver arc type and the driver arc type combination for use in the propagation delay calculation by the timing calculator 120.

Non-inverting input to output relationship refers to the logic gate configurations in which the transitional direction of both the input signal and the output signal are in the same direction (i.e., either rising or falling). On the other hand, inverting input to output relation refers to the logic gate configurations in which the transitional direction of both the input signal and the output signal are in the opposite direction. For instance, the logic gate is said to have a non-inverting input to output relationship, if a falling input signal triggers the output signal of the logic gate to fall (i.e., transit from high to low). On the other hand, the logic gate is said to have an inverting input to output relationship, if a rising input signal triggers the output signal of the logic gate to fall (i.e., transit from high to low). Similarly, the logic gate is said to have a non-inverting input to output relationship, if a rising input signal triggers the output signal of the logic gate to rise (i.e., transit from low to high). Also, the logic gate is said to have an inverting input to output relationship if a falling input signal triggers rising output signal of the logic gate.

For calculation of propagation delay T_{PHL} for a logic gate with a non-inverting input to output relationship, the receiver arc T_{IT FALL} is added to the driver arc T_{ITHLpHL}, as shown in equation EQ3 of the Table 1. For calculation of propagation delay T_{PHL} for a logic gate with an inverting input to output relationship, however, the receiver arc T_{IT RISE} is added to the driver arc T_{ITLHpHL}, as in equation EQ4 of the Table 1. For calculation of propagation delay T_{PLH} for a logic gate with a non-inverting input to output relationship, the receiver arc T_{IT RISE} is added to the driver arc T_{ITLHpLH}, as in equation EQ5 of the Table 1. For calculation of propagation delay T_{PLH} for a logic gate with a inverting input to output relationship, however, the receiver arc T_{IT FALL} is added to the driver arc T_{ITHLpLH}, as in equation EQ6 of the Table 1.

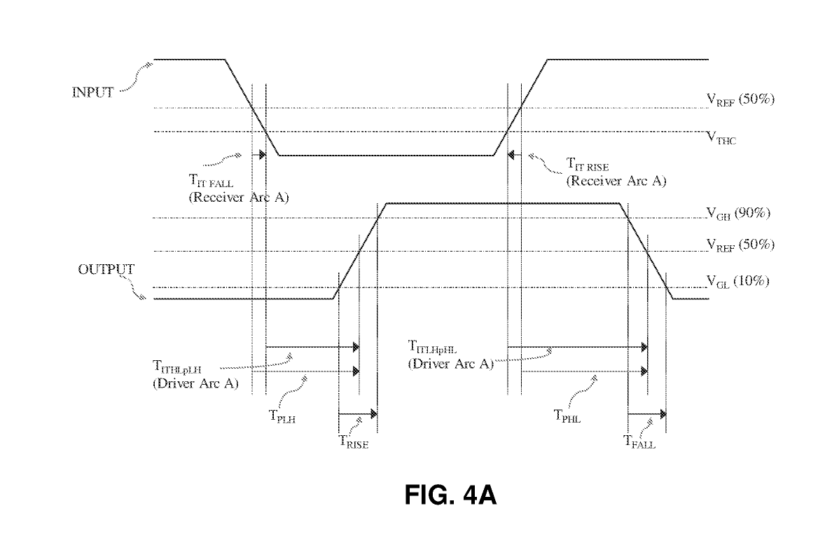

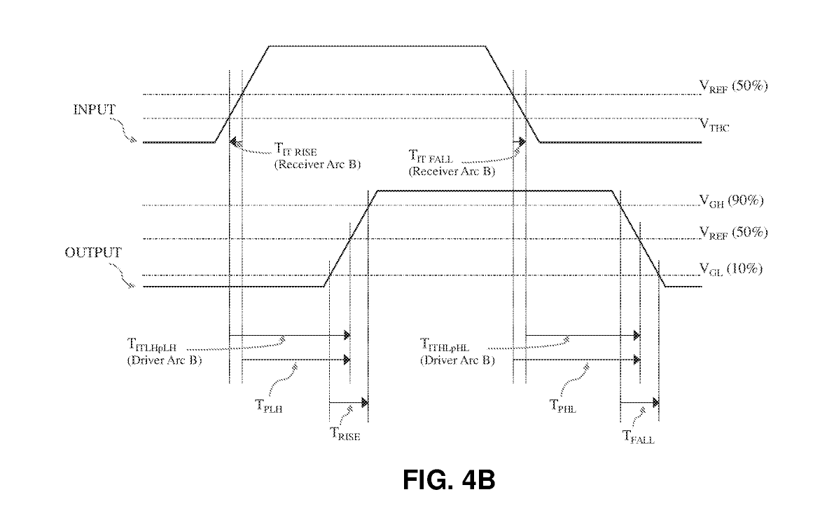

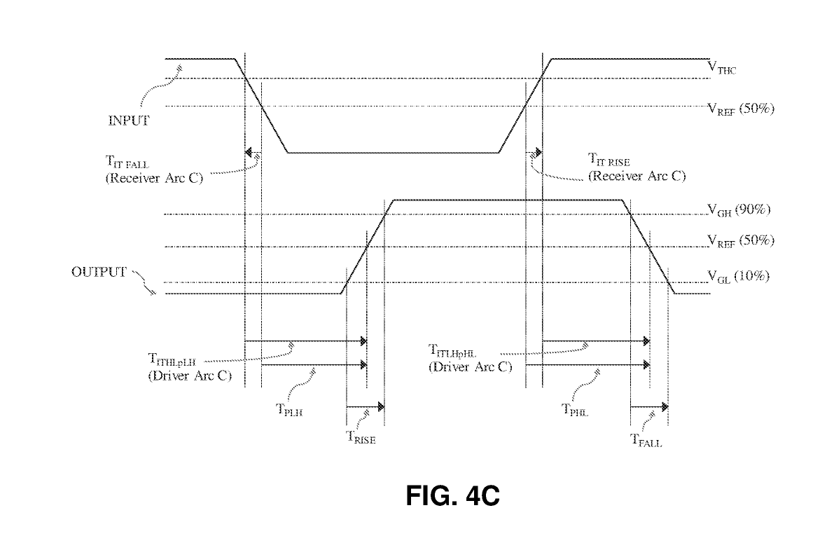

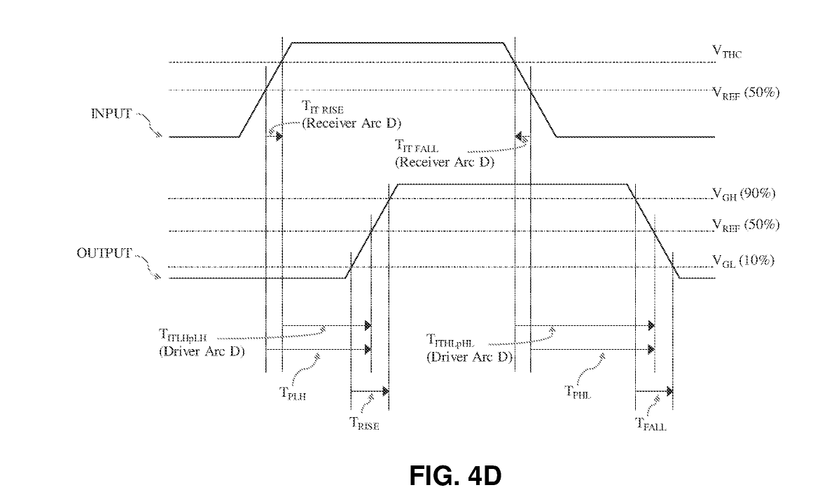

FIGS. 4A-4D are exemplary timing diagrams, each showing how propagation delay of a logic gate is constructed by the above described fashion. Referring to FIG. 4A, the timing diagram represents a situation where a logic gate is provided with an input signal and an output signal having an inverse relationship. That is, the input signal transitioning from high to low triggers the output signal of the logic gate to transit from low to high. Here, the actual circuit threshold voltage V_{THC} of the logic gate is lower than the logical threshold voltage V_{REF}.

During the time segment for the input signal at the logical threshold voltage V_{REF} to reach the circuit threshold voltage V_{THC}, denoted as the “Receiver Arc A” (T_{IT FALL}) in FIG. 4A, the logic gate is not operative to change the logic state of the output signal. Once the input signal reaches the circuit threshold voltage V_{THC}, the output driver of the logic gate is operative to cause transition of the logic state of the output signal. Such time segment is denoted as “Driver Arc A” (T_{ITHLpLH}) in FIG. 4A. The propagation delay from input to output of the logic gate, in this case T_{PLH}, is a sum of the aforementioned two timing segments Receiver Arc A (T_{IT FALL}) and Driver Arc A (T_{ITHLpLH}). The time segment for the input signal at the circuit threshold voltage V_{THC} to rise up to the logical threshold voltage V_{REF}, denoted as the “Receiver Arc A” (T_{IT RISE}) in FIG. 4A. In the “Receiver Arc A” (T_{IT RISE}), the transition of the logic state of the output signal occurs before the voltage of the input signal rises to the logical threshold voltage V_{REF}. That is, the output driver of the logic gate is operative to cause transition of the logic state of the output signal as soon as the input signal reaches the circuit threshold voltage V_{THC}. Such extended time segment from where the rising input signal is at the circuit threshold voltage V_{THC} to where the falling output signal is at the logical threshold voltage V_{REF} is denoted as “Driver Arc A” (T_{ITLHpHL}) in FIG. 4A. Again, the propagation delay from input to output of the logic gate, in this case T_{PHL}, is a sum of the aforementioned two timing segments Receiver Arc A (T_{IT RISE}) and Driver Arc A (T_{ITLHpHL}).

In the Receiver Arc A (T_{IT FALL} and T_{IT RISE}) of the propagation delay (T_{PLH} and T_{PHL}), the input signal is the output signal of the previous instance (N−1). As described above, the Receiver Arc A (T_{IT FALL} and T_{IT RISE}) of the propagation delay (T_{PLH} and T_{PHL}) is proportional to the transition time (T_{RISE} and T_{FALL}) of the previous instance (N−1). The transition time T_{RISE} and T_{FALL} are stored in the logic gate characterization database, and are available for the calculation of the Receiver Arc A (T_{IT FALL} and T_{IT RISE}) by the timing calculator 120. In this example, the falling transition time T_{FALL} and the rising transition time T_{RISE} of the input signal (i.e., the output signal of N−1 instance) retrieved from the logic gate characteristic database 130 are assumed to be 1 second for simpler explanation. When the transition direction of the input is in the falling direction, equation EQ1 is used to calculate the Receiver Arc A (T_{IT FALL}) of the propagation delay T_{PLH}.

In this example, the supply voltage is 1.0 V, and the logical threshold voltage is set to be 50% of the supply voltage (i.e., 0.5 V). Considering the noises in the supply and ground voltage rails, the V_{GH} and V_{GL} may be set to be 90% and 10% of the supply voltage (i.e., 0.9V and 0.1V), respectively. When the circuit threshold voltage V_{THC} is 0.25V, the Receiver Arc A (T_{IT FALL}) of the propagation delay is the time segment from when the voltage of the input signal falls from the logical threshold voltage V_{REF} (0.5V in this example) to the circuit threshold voltage V_{THC} (0.25V in this example). Applying these values in the equation EQ1, the Receiver Arc A (T_{IT FALL}) of the propagation delay T_{PLH} is calculated as below:

Receiver Arc A (T_{IT FALL})=0.3125 Sec.=(0.5−0.25)×1÷(0.9−0.1) EQ1:

In this example, the Driver Arc A (T_{ITHLpLH}) of the propagation delay is assumed to be 0.6875 second for simpler explanation. However, the Driver Arc A (T_{ITHLpLH}) of the propagation delay T_{PLH} is identified during characterization process of the logic gate and stored in the logic gate characterization database 130 as described above. The propagation delay T_{PLH} will be sum of 0.3125 seconds and 0.6875 seconds, which is 1 second.

When the transition direction of the input is in the rising direction, equation EQ2 is used to calculate the Receiver Arc A (T_{IT RISE}) of the propagation delay T_{PHL}. Assuming the same voltages as mentioned above, the Receiver Arc A (T_{IT RISE}) of the propagation delay T_{PHL} is calculated as below:

Receiver Arc A (T_{IT RISE})=−0.3125 Sec.=(0.25−0.5)×1÷(0.9−0.1) EQ2:

In this example, the Driver Arc A (T_{ITLHpHL}) of the propagation delay T_{PHL} is assumed to be 1.3125 second for simpler explanation. However, the Driver Arc A (T_{ITLHpHL}) of the propagation delay T_{PHL} is identified during characterization process of the logic gate and stored in the logic gate characterization database 130 as described above. The propagation delay T_{PHL} will be sum of −0.3125 seconds and 1.3125 seconds, which is 1 second.

Referring to FIG. 4B, the timing diagram represents the situation where the input signal and the output signal has non-inverse relationship. That is, the transition of the input signal from low to high triggers the output signal of the logic gate to transit from low to high. Similar to the example shown in FIG. 4A, the actual circuit threshold voltage V_{THC} of the logic gate is lower than the logical input threshold V_{REF} in the example of FIG. 4B as well. In this example, the input signal is stable and valid to change the state of the logic gate even before the voltage level of the input signal rises to the logical threshold voltage V_{REF}. In other words, the logic gate starts to act as the driving source for the next logic gate even before the input signal rises to the logical threshold voltage level V_{REF}. The propagation delay T_{PLH} from input to output of the logic gate measured from the logical threshold voltage V_{REF} of the input to the logical threshold voltage V_{REF} of the output signal will not account for the premature operation time of the logic gate from the circuit threshold voltage V_{THC} point of the input to the logical threshold voltage V_{REF} point of the input.

In case of falling input signal, the input signal will not be valid to change the state of the logic gate even after the voltage level of the input signal falls across the logical threshold voltage V_{REF}. The propagation delay T_{PHL} from input to output of the logic gate measured from the logical threshold voltage V_{REF} of the input to the logical threshold voltage V_{REF} of the output signal will account for the invalid operation time of the logic gate from the logical threshold voltage V_{REF} point of the input to the circuit threshold voltage V_{THC} point of the input.

In FIG. 4B, such valid but unaccounted time interval during which the logic gate is acting as the “driving source” is denoted as the Receiver Arc B (T_{IT RISE}), and such invalid operation time is denoted as the Receiver Arc B (T_{IT FALL}). As was in the previous example, the time interval measured from the point where the input signal is at the circuit threshold voltage V_{THC} to the point where the output signal is at the logical threshold voltage V_{REF} of the logic gate, which is denoted as Driver Arc B (T_{ITLHpLH} and T_{ITHLpHL}), is measured during the logic gate characterization phase and stored in the logic gate characterization database 130.

The propagation delay from input to output, in this case T_{PLH} or T_{PHL}, is the sum of the aforementioned two timing segments Receiver Arc B and Driver Arc B. In the Receiver Arc B (T_{IT RISE} and T_{IT FALL}) of the propagation delay T_{PLH} and T_{PHL}, the input signal is the output signal of the previous instance (N−1). As described above, the lengths of the Receiver Arc B (T_{IT RISE} and T_{IT FALL}) are proportional to the transition time (T_{RISE} and T_{FALL}) of the previous instance (N−1). The transition time (T_{RISE} or T_{FALL}) are measured during the logic gate characterization phase, and are available from the logic gate characterization database 130 for the calculation of the Receiver Arc B (T_{IT RISE} and T_{IT FALL}) by the timing calculator 120.

In the example of FIG. 4B, the transition time T_{RISE} and T_{FALL} of the input signal (i.e., the output signal of N−1 instance) retrieved from the logic gate characteristic database 130 is 1 second. When the transition direction of the input is in rising direction, equation EQ2 needs to be used to calculate the Receiver Arc B (T_{IT RISE}) of the propagation delay T_{PLH}.

For simpler explanation, the supply voltage, V_{GH}, V_{GL}, the logical threshold voltage and the circuit threshold voltage V_{THC} are assumed to be the same as the previous example explained in reference to FIG. 4A. The Receiver Arc B (T_{IT RISE}) of the propagation delay T_{PLH} is the time interval from when the voltage of the input signal rises from the circuit threshold voltage V_{THC} (0.25V in this example) to the logical threshold voltage V_{REF} (0.5V in this example). Applying these values to the equation EQ2, the Receiver Arc B (T_{IT RISE}) of the propagation delay T_{PLH} is calculated as below:

Receiver Arc B (T_{IT RISE})=−0.3125 Sec.=(0.25−0.5)×1÷(0.9−0.1) EQ2:

As mentioned, the Driver Arc B (T_{ITLHpLH}) of the propagation delay T_{PLH} is identified during characterization process of the logic gate and stored in the logic gate characterization database 130. In this example, the Driver Arc B (T_{ITLHpLH}) of the propagation delay T_{PLH} is 1.3125 seconds. Accordingly, the propagation delay T_{PLH} will be sum of −0.3125 seconds and 1.3125 seconds, which is 1 second.

When the transition direction of the input is in falling direction, equation EQ1 needs to be used to calculate the Receiver Arc B (T_{IT FALL}) of the propagation delay T_{PHL}. The Receiver Arc B (T_{IT FALL}) of the propagation delay T_{PHL} is the time interval from when the voltage of the input signal falls from the logical threshold voltage V_{REF} (0.5V in this example) to the circuit threshold voltage V_{THC} (0.25V in this example). Applying these values to the equation EQ1, the Receiver Arc B (T_{IT FALL}) of the propagation delay T_{PHL} is calculated as below:

Receiver Arc B (T_{IT FALL})=0.3125 Sec.=(0.5−0.25)×1÷(0.9−0.1) EQ1:

The Driver Arc B (T_{ITHLHpHL}) of the propagation delay T_{PHL} is identified during characterization process of the logic gate and stored in the logic gate characterization database 130. In this example, the Driver Arc B (T_{ITHLpHL}) of the propagation delay T_{PHL} is 0.6875 seconds. Accordingly, the propagation delay T_{PHL} will be sum of 0.3125 seconds and 0.6875 seconds, which is 1 second.

Referring to FIG. 4C, the timing diagram represents the situation where the input signal and the output signal has an inverse relationship. In particular, the falling input signal triggers the output signal of the logic gate to transit from low to high level, and the rising input signal triggers the output signal of the logic gate to transit from high to low level. Unlike the previous examples, the circuit threshold voltage V_{THC} of the logic gate is higher than the logical threshold voltage V_{REF} in the example of FIG. 4C. In this case, the falling input signal is stable and valid to change the state of the logic gate before the voltage level of the input signal falls down to the logical circuit threshold voltage V_{REF}. In other words, the logic gate starts to act as the driving source for the next logic gate even before the input signal falls to the logical threshold voltage level V_{REF}. As such, the propagation delay from input to output of the logic gate measured from the logical threshold voltage V_{REF} of the input to the logical threshold voltage V_{THC} of the output signal will not account for the premature operation time of the logic gate from the circuit threshold voltage V_{THC} point of the input to the logical threshold V_{REF} point of the input, which is denoted as T_{IT FALL} in FIG. 4C.

Also, it should be noted that the rising input signal becomes stable and valid to change the state of the output signal after the voltage level of the input signal crosses over the logical circuit threshold voltage V_{REF} and reaches to the circuit threshold voltage V_{THC}. In other words, the logic gate will not stop acting as the driving source for the next logic gate even though the voltage level of the input signal reaches up to the logical threshold voltage level V_{REF}. As such, the propagation delay from input to output of the logic gate measured from the logical threshold voltage V_{REF} of the input to the logical threshold voltage V_{THC} of the output signal will include the invalid operation time of the logic gate from the logical threshold V_{REF} point of the input to the circuit threshold voltage V_{THC} point of the input, which is denoted as T_{IT RISE} in FIG. 4C.

In FIG. 4C, both the unaccounted time interval and the invalidly accounted time interval during which the logic gate is acting as the “driving source” is denoted as the Receiver Arc C. As was in the previous examples, the time segment measured from the point where the input signal is at the circuit threshold voltage V_{THC} to the point where the output signal is at the logical threshold voltage V_{REF} of the logic gate, which is denoted as Driver Arc C, is measured during the logic gate characterization phase and stored in the logic gate characterization database 130. When the falling input signal triggers the output signal to transit from low to high, the length of the Driver Arc C is longer than the propagation delay T_{PLH}, which is measured from the logical threshold voltage V_{REF} point of the input signal to the logical threshold voltage V_{REF} of the output signal. On the other hand, when the rising input signal triggers the output signal to transit from high to low, the length of the Driver Arc C is shorter than the propagation delay T_{PHL}, which is measured from the logical threshold voltage V_{REF} point of the input signal to the logical threshold voltage V_{REF} of the output signal.

The propagation delay from input to output of the logic gate, the T_{PLH} and T_{PHL}, is the sum of the aforementioned two timing segments Receiver Arc C and Driver Arc C. In the Receiver Arc C of the propagation delay T_{PLH} and T_{PHL}, the input signal is the output signal of the previous instance (N−1). As described above, the length of the Receiver Arc C is proportional to the transition time (T_{RISE}, T_{FALL}) of the previous instance (N−1). The transition time (T_{RISE}, T_{FALL}) are measured during the logic gate characterization phase, and are available from the logic gate characterization database 130 for the calculation of the Receiver Arc C by the timing calculator 120.

For simpler explanation of the example shown in FIG. 4C, 1 second is used as the transition time T_{FALL} of the input signal (i.e., the output signal of N−1 instance) retrieved from the logic gate characteristic database 130. Since the transition direction of the input is in the falling direction, equation EQ1 needs to be used to calculate the Receiver Arc C of the propagation delay T_{PLH}.

In this example, the supply voltage, V_{GH}, V_{GL} and the logical threshold voltage V_{REF} are assumed to be the same as the previous examples explained in reference to FIGS. 4A and 4B. However, the circuit threshold voltage V_{THC} is higher than the logical threshold voltage V_{REF}, for instance 0.75V. The Receiver Arc C of the propagation delay T_{PLH} is the time segment from when the voltage of the input signal falls from the circuit threshold voltage V_{THC} (0.75V in this example) to the logical threshold voltage V_{REF} (0.5V in this example). Applying these values to the equation EQ1, the Receiver Arc C of the propagation delay T_{PHL} is calculated as below:

Receiver Arc C (T_{IT FALL})=−0.3125 Sec.=(0.5−0.75)×1÷(0.9−0.1) EQ1:

As mentioned, the Driver Arc C of the propagation delay T_{PLH}, that is T_{ITHLpLH}, is identified during characterization process of the logic gate and stored in the logic gate characterization database 130. In this example, the Driver Arc C (T_{ITHLpLH}) of the propagation delay T_{PLH} is 1.3125 seconds. Accordingly, the propagation delay T_{PLH} will be sum of −0.3125 seconds and 1.3125 seconds, which is 1 second.

For the rising input signal, equation EQ2 needs to be used to calculate the Receiver Arc C of the propagation delay T_{PHL}. The Receiver Arc C of the propagation delay T_{PHL} is the time interval from when the voltage of the input signal rises from the logical threshold voltage V_{REF} (0.5V in this example) to the circuit threshold voltage V_{THC} (0.75V in this example). Applying these values to the equation EQ2, the Receiver Arc C of the propagation delay T_{PHL} is calculated as below:

Receiver Arc C (T_{IT RISE})=0.3125 Sec.=(0.75−0.5)×1÷(0.9−0.1) EQ2:

As mentioned, the Driver Arc C of the propagation delay T_{PHL}, that is T_{ITLHpHL}, is identified during characterization process of the logic gate and stored in the logic gate characterization database 130. In this example, 0.6875 seconds is used as the length of the Driver Arc C (T_{ITLHpHL}) of the propagation delay T_{PHL} for the purposes of simpler explanation. Accordingly, the propagation delay T_{PHL} will be sum of 0.3125 seconds and 0.6875 seconds, which is 1 second.

Referring to FIG. 4D, the timing diagram represents the situation where the input signal and the output signal has a non-inverse relationship. In particular, the rising edge of the input signal triggers the rising transition of the output signal of the logic gate, and the falling edge of the input signal triggers the falling transition of the output signal of the logic gate. Similar to the example in FIG. 4C, the actual circuit threshold voltage V_{THC} of the logic gate is higher than the logical input threshold V_{REF} in the example of FIG. 4D. Therefore, at the logical threshold voltage level V_{REF}, the input signal is actually not stable and valid to change the logic level of the output signal. The input signal is stable and valid to change when its voltage level falls to the circuit threshold voltage V_{THC}.

During the time interval for the input signal at the logical threshold voltage V_{REF} level to rise to the circuit threshold voltage V_{THC}, the logic gate still remains as the “driven load” as the output driver of the logic gate is not operative to change the state of the output signal. When the input signal falls, the output signal of the logic gate starts to transit from high to low as soon as the falling input signal reaches to the circuit threshold voltage V_{THC}, before reaching down to the logical threshold voltage V_{REF} level.

In FIG. 4D, the time segment during which the voltage of the input signal rises up from the logical threshold voltage V_{REF} to the circuit threshold voltage V_{THC} is denoted as the Receiver Arc D (T_{IT RISE}), and the time segment during which the voltage of the input signal falls down from the circuit threshold voltage V_{THC} to the logical threshold voltage V_{REF} is denoted as the Receiver Arc D (T_{IT FALL}). Once the input signal reaches the circuit threshold voltage V_{THC}, the logic gate becomes the “driving source” as the output driver of the logic gate is operative to change the state of the output signal. Such time segment during which the logic gate is acting as the “driving source” is denoted as Driver Arc D (T_{ITLHpLH}) in FIG. 4D. The propagation delay from input to output, in this case T_{PLH}, is the sum of the aforementioned two timing segments Receiver Arc D (T_{IT RISE}) and Driver Arc D (T_{ITLHpLH}). When the falling input signal reaches the circuit threshold voltage V_{THC}, which is higher than the logical threshold voltage V_{REF}, the output driver of the logic gate becomes operative to revert the state of the output signal. The propagation delay from input to output, in this case T_{PHL}, is also the sum of the Receiver Arc D (T_{IT FALL}) and the Driver Arc D (T_{ITHLpHL}).

In the Receiver Arc D (T_{IT RISE}) of the propagation delay T_{PLH}, the input signal is the output signal of the previous instance (N−1). As described above, the Receiver Arc D (T_{IT RISE} and T_{IT FALL}) of the propagation delay (T_{PLH} and T_{PHL}) is proportional to the transition time (T_{RISE}, T_{FALL}) of the previous instance (N−1). The transition times (T_{RISE}, T_{FALL}) are stored in the logic gate characterization database 130, and are available for the calculation of the Receiver Arc D by the timing calculator 120.

In this example, 1 second is used as the transition time T_{RISE} of the input signal (i.e., the output signal of N−1 instance) retrieved from the logic gate characteristic database 130 for the purposes of simpler explanation. Since the transition direction of the input is in rising direction, equation EQ2 needs to be used to calculate the Receiver Arc D (T_{IT RISE}) of the propagation delay T_{PLH}. In this example, the supply voltage, V_{GH}, V_{GL} and the logical threshold voltage V_{REF} are assumed to be the same as the previous examples of the disclosure. However, the circuit threshold voltage V_{THC} is higher than the logical threshold voltage V_{REF}, for instance 0.75V, and the transition direction of the input signal is in the rising direction. The Receiver Arc D (T_{IT RISE}) of the propagation delay T_{PLH} is the time interval from when the voltage of the input signal rises from the logical threshold voltage V_{REF} (0.5V in this example) to the circuit threshold voltage V_{THC} (0.75V in this example). Applying these values to the equation EQ2, the Receiver Arc D (T_{IT} of the propagation delay T_{PLH} is calculated as RISE) below:

Receiver Arc D (T_{IT RISE})=0.3125 Sec.=(0.75−0.5)×1÷(0.9−0.1) EQ2:

As mentioned, the Driver Arc D (T_{ITLHpLH}) of the propagation delay T_{PLH} is identified during characterization process of the logic gate and stored in the logic gate characterization database 130. In this example, 0.6875 seconds is used as the length of the Driver Arc D (T_{ITLHpLH}) of the propagation delay T_{PLH} for the purposes of simpler explanation. Accordingly, the propagation delay T_{PLH} will be sum of 0.3125 seconds and 0.6875 seconds, which is 1 second.

Similarly, in this example, 1 second is used as the transition time T_{FALL} of the input signal (i.e., the output signal of N−1 instance) retrieved from the logic gate characteristic database 130 for the purposes of simpler explanation. When the transition direction of the input is in falling direction, equation EQ1 needs to be used to calculate the Receiver Arc D (T_{IT FALL}) of the propagation delay T_{PHL}. The Receiver Arc D (T_{IT FALL}) of the propagation delay T_{PHL} is the time interval from when the voltage of the input signal falls from the circuit threshold voltage V_{THC} (0.75V in this example) to the logical threshold voltage V_{REF} (0.5V in this example). Applying these values to the equation EQ1, the Receiver Arc D (T_{IT FALL}) of the propagation delay T_{PHL} is calculated as below:

Receiver Arc D (T_{IT FALL})=−0.3125 Sec.=(0.5−0.75)×1÷(0.9−0.1) EQ1:

The Driver Arc D (T_{ITLHpHL}) of the propagation delay T_{PHL} is identified during characterization process of the logic gate and stored in the logic gate characterization database 130. In this example, 1.3125 seconds is used as the length of the Driver Arc D (T_{ITHLpHL}) of the propagation delay T_{PHL} for the purposes of simpler explanation. Accordingly, the propagation delay T_{PHL} will be sum of −0.3125 seconds and 1.3125 seconds, which is 1 second.

It should be appreciated that the total length of the propagation delay (T_{PHL} or T_{PLH}) remains the same whether it is defined using the conventional model or using the segmented propagation delay model of the present disclosure. However, the segmented propagation delay model of the present disclosure allows for accurate propagation delay calculation at different PVT corners even without having to perform time consuming characterization and validation processes.

When simulating the propagation delay at different PVT corners, a derating factor is simply applied to the entire propagation delay (e.g., T_{PHL} and T_{PLH}) as a whole. Such linear interpolation of T_{PHL} and T_{PLH} as a lump sum value cannot provide enough accuracy, especially in table-look-up method, because the driving cell characteristic and receiving cell characteristic are mixed in the propagation delay (T_{PHL}, T_{PLH}) and sensitivity to PVT corner variation for each cell is different for one another. In other words, a part of the propagation delay is due to the transition delay of the previous logic gate (N−1) whereas another part of the propagation delay is due to the transition delay of the present logic gate (N). The derating factor suitable for the current logic gate (N) is not necessarily a suitable derating factor for the previous logic gate (N−1) because of the characteristic differences between the current logic gate (N) and the previous logic gate (N−1). Such a problem is solved in the segmented propagation delay model of the present disclosure.

In this invention, migration to other PVT corner can be done at individual term based on each term's behavioral characteristics. PVT variation characteristic of Driver Arc (T_{ITHLpHL}, T_{ITLHpHL}, T_{ITHLpLH} and T_{ITLHpLH}) of the present cell (N) is affected by performance variation of all transistors in the present cell (N), but PVT variation characteristic of Receiver Arc (T_{IT RISE} and T-FALL) of previous cell (N−1) is determined by only the last stage output driver transistors of the previous cell (N−1).

PVT migration of the Driver Arc of the propagation delay (T_{ITHLpHL}, T_{ITLHpHL}, T_{ITHLpLH}, T_{ITLHpLH}) can be done within design tolerable margin because each timing characteristic is extracted from the exact logic gate under testing. Also, PVT migration of the transition time (T_{RISE} and T_{FALL}) of a given logic gate can be obtained within tolerable margin as such characteristics are extracted from the exact logic gate under testing. These parameters are independent from the effect of the voltage gap between logic threshold voltage V_{REF} and circuit threshold voltage V_{THC}. Accordingly, PVT migration through “linear interpolation” of these parameters is possible.

PVT migration of the Driver Arc of the propagation delay as well as the transition times can be performed, for instance, by the following equations:

<New PVT migration method in this invention>

Driver Arc (T_{ITHLpHL}) in PVT2=derating factor×Driver Arc (T_{ITHLpHL}) in PVT1

Driver Arc (T_{ITLHpHL}) in PVT2=derating factor×Driver Arc (T_{ITLHpHL}) in PVT1

Driver Arc (T_{ITHLpLH}) in PVT2=derating factor×Driver Arc (T_{ITHLpLH}) in PVT1

Driver Arc (T_{ITLHpLH}) in PVT2=derating factor×Driver Arc (T_{ITLHpLH}) in PVT1

T_{RISE (N-1)} in PVT2=derating factor×T_{RISE (N-1)} in PVT1

T_{FALL (N-1)} in PVT2=derating factor×T_{FALL (N-1)} in PVT1

Using the Driver Arc values and the transition time values at PVT2, propagation delay at PVT2 can be calculated by using the following equations EQ7 through EQ10.

EQ7 (falling input case with non-inversion input to output relationship)

T_{PHL} in PVT2=T_{ITHLpHL} in PVT2+(V_{REF}−V_{THC})×T_{FALL (N-1)} in PVT2÷(V_{GH}−V_{GL})

EQ8 (rising input case with inversion input to output relationship)

T_{PHL} in PVT2=T_{ITHLpHL} in PVT2+(V_{THC}−V_{REF})×T_{RIS (N-1)} in PVT2÷(V_{GH}−V_{GL})

EQ9 (falling input case with inversion input to output relationship)

T_{PHL} in PVT2=T_{ITHLpHL} in PVT2+(V_{REF}−V_{THC})×T_{FALL (N-1)} in PVT2÷(V_{GH}−V_{GL})

EQ 10 (rising input case with non-inversion input to output relationship)

T_{PHL} in PVT2=T_{ITHLpHL} in PVT2+(V_{THC}−V_{REF})×T_{RISE (N-1)} in PVT2÷(V_{GH}−V_{GL})

The derating factor is already applied to the transition time at PVT2, and the Receiver Arc of the propagation delay is obtained by using the transition time at PVT2. The derating factor is applied to the Driver Arc of the propagation delay to obtain the value of the Driver Arc at PVT2. Once the Receiver Arc at PVT2 and the Driver Arc at PVT2 are obtained, the propagation delay at PVT2 can be obtained by adding the Receiver Arc at PVT2 and the Driver Arc at PVT2.

This segmented delay model provides benefits not only in terms of the cell library development cost, but it enables to procure high performance and low power consumption VLSI chip design. When building a VLSI chip with a high performance and low power consumption design, a large amount of timing margin is allocated at critical timing paths to guarantee the logic gate operation in its operation condition range. However, the present invention allows for more accurate PVT migration to keep the timing margin at minimum level. Because proper logic gate operation can be guaranteed with less timing margin, computing power per clock toggling can be improved, which in turn, allows for more tasks to be completed in less number of clock toggles or in the same number of clock of higher operating frequency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A segmented propagation delay modeling computer system, comprising:
a processor;
memory operably associated with the at least one processing unit; and
a cell library building tool storable in memory and executable by the processor for identifying a propagation delay parameter between an input signal and an output signal provided at an input node and an output node of a circuit, respectively, said propagation delay parameter being a sum of a receiver arc and a driver arc,
wherein the receiver arc is a length of time for a voltage of the input signal changes between a circuit threshold voltage of the input node and a logical threshold voltage of the input node, and
wherein the driver arc is a time interval from a point in time when the input signal is at the circuit threshold voltage of the input node until a nearest point in time when the output signal is at a logical threshold voltage of the output node.

2. The computer system of claim 1, wherein said at least one propagation delay parameter is indicative of a propagation delay when the input signal changing from its predetermined high voltage level to its predetermined low voltage level and the output signal changing from its predetermined high voltage level to its predetermined low voltage level.

3. The computer system of claim 2, wherein the receiver arc is a length of time for the input signal to change between the circuit threshold voltage of the input node and the logical threshold voltage of the input node in a falling direction, which is calculated according to the following equation:
T_{IT FALL (N)}=(V_{REF}−V_{THC})×T_{FALL (N-1)}÷(V_{GH}×V_{GL}), equation (1):
in which T_{IT FALL} denotes the receiver arc, V_{REF} denotes the logical threshold voltage of the input node, V_{THC} denotes the circuit threshold voltage of the input node, V_{GH} is a predetermined high voltage level of the input signal, V_{GL} is a predetermined low voltage level of the input signal, and T_{FALL} is a length of time for the input signal to reach from its predetermined high voltage level to the predetermined low voltage level.

4. The computer system of claim 1, wherein said at least one propagation delay parameter is indicative of a propagation delay when the input signal changing from its predetermined low voltage level to its predetermined high voltage level and the output signal changing from its predetermined high voltage level to its predetermined low voltage level.

5. The computer system of claim 4, wherein the receiver arc is a length of time for the input signal to change between the circuit threshold voltage of the input node and the logical threshold voltage of the input node in a rising direction, which is calculated according the following equation:
T_{IT RISE (N)}=(V_{THC}−V_{REF})×T_{RISE (N-1)}÷(V_{GH}×V_{GL}), equation (2):
in which T_{IT RISE} denotes the receiver arc, V_{REF} denotes the logical threshold voltage of the input node, V_{THC} denotes the circuit threshold voltage of the input node, V_{GH} is a predetermined high voltage level of the input signal, V_{GL} is a predetermined low voltage level of the input signal, and T_{RISE} is a length of time for the input signal to reach from its predetermined high voltage level to the predetermined low voltage level.

6. The computer system of claim 1, wherein said at least one propagation delay parameter is indicative of a propagation delay when the input signal changing from its predetermined high voltage level to its predetermined low voltage level and the output signal changing from its predetermined low voltage level to its predetermined high voltage level.

7. The computer system of claim 6, wherein the receiver arc is a length of time for the input signal to change between the circuit threshold voltage of the input node and the logical threshold voltage of the input node in a falling direction, which is calculated according the following equation:
T_{IT FALL (N)}=(V_{REF}−V_{THC})×T_{FALL (N-1)}÷(V_{GH}×V_{GL}), equation (1):
in which T_{IT FALL} denotes the receiver arc, V_{REF} denotes the logical threshold voltage of the input node, V_{THC} denotes the circuit threshold voltage of the input node, V_{GH} is a predetermined high voltage level of the input signal, V_{GL} is a predetermined low voltage level of the input signal, and T_{FALL} is a length of time for the input signal to reach from its predetermined high voltage level to the predetermined low voltage level.

8. The computer system of claim 1, wherein said at least one propagation delay parameter is indicative of a propagation delay when the input signal changing from its predetermined low voltage level to its predetermined high voltage level and the output signal changing from its predetermined low voltage level to its predetermined high voltage level.

9. The computer system of claim 8, wherein the receiver arc is a length of time for the input signal to change between the circuit threshold voltage of the input node and the logical threshold voltage of the input node in a rising direction, which is calculated according to the following equation:
T_{IT RISE (N)}=(V_{THC}−V_{REF})×T_{RISE (N-1)}÷(V_{GH}×V_{GL}), equation (2):
in which T_{IT RISE} denotes the receiver arc, V_{REF} denotes the logical threshold voltage of the input node, V_{THC} denotes the circuit threshold voltage of the input node, V_{GH} is a predetermined high voltage level of the input signal, V_{GL} is a predetermined low voltage level of the input signal, and T_{RISE} is a length of time for the input signal to reach from its predetermined high voltage level to the predetermined low voltage level.

10. A method of building a cell library with segmented propagation delay model, comprising:
identifying a circuit threshold voltage of an input node of the circuit;
identifying a plurality of logic gate characteristics of the logic gate, said plurality of logic gate characteristics including a driver arc and a transition time, in which said driver arc is a length in time measured from when an input signal reaches the circuit threshold voltage of the input node and until when an output signal reaches a logical threshold voltage of an output node, and said transition time is a length in time for the input signal to reach from its predetermined high voltage level to the predetermined low voltage level or to reach from its predetermined low voltage level to the predetermined high voltage level;
identifying a receiver arc, which is a length in time for the input signal changes between the circuit threshold voltage of the input node and a logical threshold voltage of the input node; and
identifying a propagation delay and storing the propagation delay in the cell library, wherein the propagation delay is defined as a sum of the receiver arc and the post-input propagation time.

11. The method of creating a cell library for an logic gate of claim 10, wherein said propagation delay represents a first type of propagation delay when the input signal is changing from its predetermined high voltage level to its predetermined low voltage level and the output signal is changing from its predetermined high voltage level to its predetermined low voltage level.

12. The method of creating a cell library for an logic gate of claim 11, wherein the receiver arc is a length in time for a voltage of the input signal to change between the circuit threshold voltage of the input node and the logical threshold voltage of the input node in a falling direction, which is calculated according to the following equation:
T_{IT FALL (N)}=(V_{REF}−V_{THC})×T_{FALL (N-1)}÷(V_{GH}×V_{GL}), equation (1):
in which T_{IT FALL} denotes the receiver arc, V_{REF} denotes the logical threshold voltage of the input node, V_{THC} denotes the circuit threshold voltage of the input node, V_{GH} is a predetermined high voltage level of the input signal, V_{GL} is a predetermined low voltage level of the input signal, and T_{FALL} is a length of time for the input signal to reach from its predetermined high voltage level to the predetermined low voltage level.

13. The method of creating a cell library for an logic gate of claim 10, wherein said propagation delay represents a second type of propagation delay when the input signal changing from its predetermined low voltage level to its predetermined high voltage level and the output signal changing from its predetermined high voltage level to its predetermined low voltage level.

14. The method of creating a cell library for an logic gate of claim 13, wherein the receiver arc is a length in time for a voltage of the input signal to change between the circuit threshold voltage of the input node and the logical threshold voltage of the input node in a rising direction, which is calculated according to the following equation:
T_{IT RISE (N)}=(V_{THC}−V_{REF})×T_{RISE (N-1)}÷(V_{GH}×V_{GL}), equation (2):
in which T_{IT RISE} denotes the receiver arc, V_{REF} denotes the logical threshold voltage of the input node, V_{THC} denotes the circuit threshold voltage of the input node, V_{GH} is a predetermined high voltage level of the input signal, V_{GL} is a predetermined low voltage level of the input signal, and T_{RISE} is a length of time for the input signal to reach from its predetermined high voltage level to the predetermined low voltage level.

15. The method of creating a cell library for an logic gate of claim 10, wherein said propagation delay represents a third type of propagation delay when the input signal changing from its predetermined high voltage level to its predetermined low voltage level and the output signal changing from its predetermined low voltage level to its predetermined high voltage level.

16. The method of creating a cell library for an logic gate of claim 15, wherein the receiver arc is a length in time for a voltage of the input signal to change between the circuit threshold voltage of the input node and the logical threshold voltage of the input node in a falling direction, which is calculated according to the following equation:
T_{IT FALL (N)}=(V_{REF}−V_{THC})×T_{FALL (N-1)}÷(V_{GH}×V_{GL}), equation (1):
in which T_{IT FALL} denotes the receiver arc, V_{REF} denotes the logical threshold voltage of the input node, V_{THC} denotes the circuit threshold voltage of the input node, V_{GH} is a predetermined high voltage level of the input signal, V_{GL} is a predetermined low voltage level of the input signal, and T_{FALL} is a length of time for the input signal to reach from its predetermined high voltage level to the predetermined low voltage level.

17. The method of creating a cell library for an logic gate of claim 10, wherein said propagation delay represents a fourth type of propagation delay when the input signal changing from its predetermined low voltage level to its predetermined high voltage level and the output signal changing from its predetermined low voltage level to its predetermined high voltage level.

18. The method of creating a cell library for an logic gate of claim 13, wherein the receiver arc is a length in time for a voltage of the input signal to change between the circuit threshold voltage of the input node and the logical threshold voltage of the input node in a rising direction, which is calculated according to the following equation:
T_{IT RISE (N)}=(V_{THC}−V_{REF})×T_{RISE (N-1)}÷(V_{GH}×V_{GL}), equation (2):
in which T_{IT RISE} denotes the receiver arc, V_{REF} denotes the logical threshold voltage of the input node, V_{THC} denotes the circuit threshold voltage of the input node, V_{GH} is a predetermined high voltage level of the input signal, V_{GL} is a predetermined low voltage level of the input signal, and T_{RISE} is a length of time for the input signal to reach from its predetermined high voltage level to the predetermined low voltage level.

19. The method of creating a cell library for an logic gate of claim 10, wherein the logical threshold voltage of the input node is defined as 50% of the difference between the predetermined high voltage level and the predetermined low voltage level of the input signal, and wherein the logical threshold voltage of the output node is defined as 50% of the difference between a predetermined high voltage level and a predetermined low voltage level of the output signal.

20. The method of creating a cell library for an logic gate of claim 10, further comprising:
adjusting the driver arc and the transition time with a derating factor.
